(19) United States
(12) Patent Application Publication
(10) Pub. No.: US 2024/0218793 A1
(43) Pub. Date: Jul. 4, 2024

(54) ROCK ANCHOR COMPRISING SENSOR FOR MEASURING MECHANICAL STRESS

(71) Applicant: Alois Homer, Wein (AT)

(72) Inventor: Alois Homer, Wein (AT)

(21) Appl. No.: 18/569,347

(22) PCT Filed: Jun. 26, 2022
(86) PCT No.: PCT/AT2022/060221

§ 371 Date: Dec. 12, 2023

(30) Foreign Application Priority Data
Jul. 1, 2021 (AT) A 60185/2021

(51) Int. Cl. E21D 21/02; G01B 7/16; G01L 1/22; G01L 5/00

(52) U.S. Cl. CPC E21D 21/02; G01B 7/18; G01L 1/2212; G01L 1/2287; G01L 5/0004

(57) ABSTRACT

A sensor carrier (16; 16′; 16a, 16b, 16c) for a device (10; 10′) for fastening an object (11) to a support element (12) and/or for stabilizing the support element (12) is provided. The device (10; 10′) has a condition monitoring system for determining a deformation and a mounting body (13) with a mounting portion (14; 14′) for insertion into the support element (12). The mounting body (13; 13a, 13b; 13a, 13b, 13c) is designed to accommodate the sensor carrier. The sensor carrier (16; 16′; 16a, 16b, 16c) includes at least one conductive pathway (17; 17a, 17b), which is electrically conductive and applied along a strip-shaped path for measuring mechanical stress on the mounting portion (14; 14′).

### TECHNICAL FIELD

The present invention relates to devices for fixing and/or reinforcing bodies (support elements), in particular a mountain anchor, support anchor, reinforcing bar, screw or bolt, or a dowel, and a method for fastening an object to a support element and a method for stabilizing or reinforcing a support element, wherein the device has a condition monitoring for determining a deformation. Furthermore, the present invention relates to a method for producing such a device.

### BACKGROUND OF THE INVENTION

Anchors, especially tension anchors, have long been known in civil engineering. Building parts were and are effectively braced against each other by providing tension anchors, thus achieving mutual support. In particular, mountain anchors are used in mines and in construction above and below ground in large numbers to secure the rock (solid rock or loose rock) and also structures such as retaining walls, dams for loose material, mud ponds, etc. Anchors are inserted into boreholes and anchored therein. The anchoring can be done by mortar or adhesive over the length of the anchor, by friction along the borehole wall, or by mechanical anchoring in the borehole.

An anchor can also be driven into loose material or semi-solid material. By anchoring itself or anchoring the anchor in the rock (solid rock or loose rock) or structure, it is internally stabilized. Support anchors, for example, secure retaining walls to the rock that needs to be supported.

Further applications are in the field of underground mining for face stabilization, injection work, portal stabilization, dome foot piles, as roof and butt anchors, radial rock bolts, pre-anchoring devices, as well as for suspensions. In civil engineering, there are applications in the field of slope stabilization, back anchoring, uplift protection, pile foundations, rockfall and avalanche protection, soil improvement, for supports and as tension anchors.

Anchors have a rod-shaped form and a length that is adapted to the object (rock, structure) to be secured. Anchors can have lengths of less than one meter up to 100 meters or more. Suitable anchors can be made of high-strength material, typically steel, but also plastics, composite materials, or renewable raw materials such as wood and bamboo. If the rock or other material surrounding the anchor moves, it exerts forces on the anchor that induce mechanical stresses in the anchor. The anchor begins to deform.

Similarly, reinforcing steel is embedded in concrete during concreting work to give it higher strength, particularly higher tensile strength. Such concreted and reinforced concrete is called ferroconcrete. If forces now act on the ferroconcrete structure, they are also transferred to the embedded reinforcement, which begins to deform.

Furthermore, when objects are fastened to corresponding support elements (rock or structures) by means of devices such as screws, bolts, or dowels, mechanical stresses also arise when the devices are introduced into the support elements, for example, by means of screwing or pressing. These mechanical stresses also lead to a deformation of the device.

The document AT394449B discloses a device for determining tensile and/or compressive stresses along a borehole in natural and/or artificial substrate, e.g., rock, concrete, etc., with a tube, especially a metallic tube, supported by friction in the substrate or in the borehole, wherein the tube is supported by means of a support device, such as a thread on the tube and a nut, and a wedge, in the substrate or in the borehole and measuring sensors (strain gauges) are provided in the interior of the tube, each of which is connected to the tube directly or indirectly, preferably over the entire surface, in the area of its two ends at least at two points, which are in particular in the longitudinal direction of the tube.

### SUMMARY OF THE INVENTION

It is an object of the present invention to monitor the stability of a fastening between an object and a support element, or a consolidation itself, with an improved device, and to provide a device and a sensor carrier for such a device.

The device comprises a mounting body with a supporting element or fastening section for insertion into the support element or for fastening the object to the support element, and a sensor carrier accommodated in the mounting body, comprising a conductor track that is electrically conductive and applied along a track-shaped course for measuring mechanical stress (which particularly causes deformation of the device) on the sensor carrier (fastening section). The mounting body comprises a head section for coupling with an evaluation unit. The conductor track is designed such that it can be coupled or supplied with electrical energy from the evaluation unit from the head section, wherein the electrical resistance of the conductor track is indicative of the deformation of the mounting body in the fastening section.

Furthermore, it is an object of the present invention to provide a sensor carrier for a device for fastening an object to a support element and/or for stabilizing the support element, where the device has a condition monitoring for determining a deformation and a mounting body with a mounting section for insertion into the support element, where the mounting body is designed to accommodate the sensor carrier, and where the sensor carrier comprises a conductor track which is electrically conductive and applied along a track-shaped course for measuring mechanical stress on the sensor carrier.

According to an object of the invention, a method for producing a device ( ) for fastening an object ( ) to a support element ( ) and/or for stabilizing the support element is provided, wherein the method comprises providing a mounting body with a mounting section for insertion into the support element; providing a sensor carrier where the mounting body is provided and designed to accommodate the sensor carrier; and producing an electrically conductive conductor track along a track-shaped course on the sensor carrier for measuring mechanical stress on the mounting section, where the mounting body has a head section for coupling with an evaluation unit, and where the sensor carrier is designed such that the conductor track can be supplied with electrical energy from the head section, preferably coupled with the evaluation unit, whereby the electrical resistance of the conductor track is indicative of the deformation of the mounting body in the fastening section.

According to another object of the invention, a method for placing a device for determining mechanical loads, particularly tensile and/or compressive stresses, and/or physical loads along a borehole in a substrate, preferably a support element, particularly a mountain/tunnel wall, is provided. The method advantageously comprises the steps of:
making a borehole in the substrate; inserting at least one mounting body in/on the borehole; introducing a bonding agent, particularly an adhesive, a quick-setting concrete or binder, into the borehole for fastening the mounting body; supporting the mounting body at one end at the borehole opposite the substrate by means of a supporting device, particularly by a thread protruding from the mounting body out of the borehole with a nut, preferably with an additional wedge or plate arranged between the nut and the substrate; and accommodating the sensor carrier in the interior of the mounting body in the borehole.

According to one embodiment, the sensor carrier is designed as an extruded plastic profile. Depending on the physical or chemical requirements, the sensor carrier can be made of materials such as ABS (Acrylonitrile Butadiene Styrene copolymer), HDPE (High Density Polyethylene), PC (Polycarbonate), PE (Polyethylene), PET (Polyethylene Terephthalate), PP (Polypropylene), PUR (Polyurethane), PVC (Polyvinyl Chloride), and various mixtures of plastics.

In one embodiment, the sensor carrier preferably has a substantially circular tube profile.

In one embodiment, the sensor carrier has at least one groove, preferably on the outer wall in the longitudinal extension of the sensor carrier.

In one embodiment, the electrically conductive conductor track is arranged in the groove and leads to a contact surface or a contact region in one or each end section of the groove respectively the sensor carrier.

In one embodiment, the contact surface or each contact region includes a conductive elastomer body, in particular a flexible, spatially extended, shape-changing, and electrically conductive body. The conductive elastomer body can be formed as a continuous conductive elastomer, in particular a homogeneous mixture of electrically conductive fillers such as nickel-coated graphite, silver-coated glass, silver-coated copper, and silver-coated aluminum.

In one embodiment, the sensor carrier and/or the at least one groove have differently designed locking contours for a locking connection. In an advantageous development, the locking contours at one end section of the groove (at one of the two ends of the sensor carrier) comprise at least one locking projection that is raised transversely to the longitudinal direction of the groove, and at another end section of the groove (at the other end of the sensor carrier) at least one locking recess that is recessed transversely to the longitudinal direction of the groove, wherein the locking recess and the locking projection are designed to match each other in shape, in particular complementary to each other, so that the locking projection can be sunk into the locking recess and engage therein when coupling (mechanical connection) of the sensor carrier with another such sensor carrier is made, so that an electrical connection of the electrically conductive conductor track of one sensor carrier is formed or can be made with the coupled other such sensor carrier, in particular by mutual contacting (touching) of the respective elastomer bodies of the coupled sensor carriers. It should be understood that for this purpose, the respective diameters or cross-sections of the ends of the sensor carriers to be co-operating are advantageously adjusted or designed accordingly, i.e., adapted or correspondingly designed diameters or cross-sections of the ends of the sensor carriers are present. According to one embodiment, the locking contours advantageously include several locking recesses that are arranged one after the other and/or at a distance from each other in the longitudinal direction of the groove and/or the sensor carrier, so that the at least one locking projection can optionally engage one of the several locking recesses. Alternatively or additionally, several such locking projections can also be provided, of which one can engage the at least one locking recess, wherein the mentioned several locking projections can be arranged one after the other and/or at a distance from each other in the longitudinal direction of the groove.

The locking contours, especially in the form of the mentioned locking projections and recesses, can be undercut viewed in the longitudinal direction of the groove, whereby the undercuts on the one and other end sections of the groove are formed to match each other, so that an engaged pair of undercuts (each from the corresponding end of the groove of the two sensor carriers to be coupled) engages each other transversely to the longitudinal direction of the groove and/or the sensor carrier.

Due to the undercut of the locking contours, there is an overlap of the respective locking contour pair—viewed in the longitudinal direction of the groove—in the engaged position.

At least one of the mentioned locking contours, for example, the locking projection or the locking recess or both, is itself elastically formed or arranged on an elastically formed part or arranged on a movably mounted, elastically prestressed part, so that at least one of the lockable locking contours can be moved so far transversely to the longitudinal direction of the groove for disengagement that the locking contour can be pushed over the other locking contour.

In an advantageous further development of the invention, the locking contours may include a ribbed and/or corrugated surface structure, which surface structure can be brought into positively locking engagement with a counter contour piece (at the other end of the groove) by elastic and/or plastic deformation of the surface structure and/or the mentioned counter contour piece during the axial fitting of one end of a first sensor carrier onto or into the corresponding end of a second sensor carrier.

Advantageously, the ribbed surface structure can include a plurality of holding ribs, which are staggered one after the other in the longitudinal direction of the groove, preferably arranged at least partially around the circumference of the groove. The mating counterpiece can include at least one holding rib on the circumference of the groove of the groove and/or the sensor carrier, which can advantageously be provided at least partially on an inner circumferential side of the groove, in particular in a plug-through recess. The staggered arrangement of the holding ribs allows for a relatively large adjustment range and a secure connection.

In an advantageous development of the invention, the ribbed or corrugated surface structure or the mating counterpiece cooperating therewith can be designed in such a way that different actuating and holding forces result, in particular such that the force necessary for interlocking the respective ends of two sensor carriers is smaller than the force necessary for the opposite, axial release of the latching mechanism, if a releasable connection is to be provided.

Such a design of the corrugation or ribbing can combine a high level of operating comfort during assembly with sufficiently high holding forces. The relatively low plug-on forces enable easy manual insertion and thus precise, coordinated positioning, while the higher release forces ensure that the locking part is held sufficiently on the actuation bolt and secured against slipping down.

In particular, the holding ribs provided in succession on the groove and/or the holding rib provided on the mating counterpiece can be designed in a saw-tooth shape, i.e. have differently inclined flanks, which engage with the respective mating contour in such a way that the interlocking occurs more easily under elastic and/or plastic deformation of the components involved than the reverse pulling or pushing apart.

According to one embodiment, the sensor carrier has at least a first groove and a second groove, each preferably on the outer wall in the longitudinal extension of the sensor carrier. The first and second grooves are spaced apart from each other (on the circumference of the sensor carrier), preferably opposite each other (e.g. diametrically). Other distances are also possible, for example 30°, 60°, 90°.

According to one embodiment, the at least one (or each) groove is arranged or designed parallel to the longitudinal axis of the sensor carrier. According to another embodiment, the at least one (or each) groove is arranged according to a helix on the sensor carrier.

According to one embodiment, when coupling two ends of sensor carriers, the respective contact surface or contact area is brought into electrically conductive connection with the respective conductive elastomer body, so that a continuous electrically conductive sensor body assembly is formed from at least two sensor carriers.

The sensor carrier itself may include an energy source, such as a battery. Remote energy could also be fed wirelessly, in the sense of RFID technology, where the required energy is transmitted wirelessly, for example, through inductive coupling. The conductor consists of an electrically conductive material or a dense arrangement of electrically conductive particles, such as copper, aluminum, or silver. The conductor tracks can be applied to a (elastomeric) conductor track substrate (elastomer substrate) based on initially liquid metal. The liquid metal can be a (eutectic) metal alloy. For example, Galinstan is a eutectic alloy of gallium, indium, and tin. For example, the alloy may contain a larger amount of gallium than a quantity of indium or tin. For example, the alloy may be an alloy containing 65 to 86 wt.-% gallium, 5 to 22 wt.-% indium, and 1 to 11 wt.-% tin. Furthermore, conductive carbon particles, e.g., nanotubes or soot, can be used. In one embodiment, a metal precursor is applied to a surface of the elastomer substrate. The metal precursor can include a salt or salt solution of a metal (e.g. silver) or a complex of a metal. In one embodiment, the solid metal layer includes at least one element (or metal) selected from the group consisting of copper, silver, gold, and platinum. For example, structured metal tracks can be applied to the sensor carrier and then Galinstan can be formed on the metal tracks in a dipping bath.

Additionally, the conductor track can consist of conductive ink described below. The conductor track can be powered with electrical energy in such a way that an electrical resistance of the conductor track is measurable.

The conductor track is fixed to the sensor carrier in such a way that the conductor track follows corresponding deformations or movements of the hollow anchor provided with the sensor device. If the hollow anchor is compressed, stretched, or interrupted, the conductor track is correspondingly deformed or interrupted. A corresponding deformation of the conductor track accordingly leads to a change in the conductive cross-section of the conductor track and also to a change in the density of the conductive particles in the conductor track, so that a resistance change in the conductor track is caused accordingly. Accordingly, a resistance change of the conductor track is indicative of a deformation of the conductor track itself and accordingly of the hollow anchor.

The term “conductive ink” refers to a material combination comprising a carrier material in which conductive particles, such as silver, aluminum, or copper particles, are introduced and present in the carrier material. The carrier material is, for example, a viscous fluid that hardens or evaporates after the conductive ink is applied, so that the particles of the conductive ink themselves adhere to a surface of the sensor carrier or section.

According to another exemplary embodiment, the conductor track has a carrier material in which conductive particles are embedded. The carrier material is, for example, a solid or highly viscous material in which conductive particles are present in a certain density or in a certain arrangement to one another. The density of the conductive particles determines the electrical conductivity and thus a specific resistance. A corresponding carrier material with conductive particles can be applied as a liquid or viscous conductive ink to the fastening area.

According to another exemplary embodiment of the method, the conductor track is produced by applying electrically conductive ink comprising the carrier material, which has dissolved conductive particles. The electrically conductive ink is applied in liquid form onto the sensor carrier. The applied carrier material is solidified so that the arrangement of the conductive particles in the carrier material is fixed.

The carrier material may be present in the conductive ink as a liquid monomer, which is later polymerized, or as a polymer. In the liquid carrier material, the conductive particles are dissolved or present as a salt solution (e.g. silver salt solution). Subsequently, the carrier material is solidified, e.g. by adding another binder, by thermal treatment, and/or by radiation (e.g. light, UV light), and the density or arrangement of the conductive particles in the carrier material is fixed.

As described in more detail below, the conductive ink can be efficiently applied to the carrier in a technically simple manner, with any desired course of the conductor track possible. In the conductive ink, the conductive particles are packed so densely that a constant electrical conductivity exists between the particles. When the conductor track is deformed (stretched, constricted or compressed), the conductive particles are packed more densely or less densely in certain areas, thereby affecting the electrical resistance of the conductor track. Based on this changed electrical resistance, the type and size of the deformation of the fastening section can be concluded.

The conductor track made of, for example, conductive ink can consist of a conductive composite material, in which a polymeric part (carrier material), e.g. made of synthetic resin, is responsible for the stretchability, while, for example, percolated conductive fillers/particles enable efficient electrical charge transfer. Conductive fillers can be based on carbon (e.g. graphite, amorphous carbon, carbon nanotubes (CNTs), graphene, pyrolyzed bacterial cellulose) or metallic (e.g. metal nanowires, microflakes, micropowders, microflowers and nanoparticles).

The conductive ink, which provides a source of transition metal ions, a reducing agent and/or a reducing compound, and a dissolved polymer or a polymerizable polymer precursor, particularly a monomer, can lead to the formation of a percolated network of metal nano- or microstructures or embedded metal nanoparticles (particularly homogeneously dispersed) in a polymer matrix (of a previously dissolved polymer or in the case of a polymerizable polymer precursor, of the polymer formed during polymerization) through thermal treatment in situ by reducing the transition metal ions and a polymerization reaction (in the case of a polymerizable polymer precursor).

The space between the metallic structures (particles) can be filled by the polymer and contribute to the formation of a polymer network that connects these metallic structures (“glues” them) together. In a similar way, it can also fill the space between these metallic structures in the case of a dissolved polymer.

This can result in a composite material, which can also be referred to as an “in situ nanocomposite” (ISNC), that has electrical conductivity (with respect to the metallic structure or nanoparticles) as well as deformability such as elasticity, flexibility, stretchability or plasticity (with respect to the polymer matrix), and can thus also be referred to as a plastic or elastic conductor.

The electrical conductivity of the resulting ISNCs can be maintained even at high strain values (for example, it can be stretched up to 200% with a very low relative resistance ratio, defined as R/R0, where R and R0 are the resistance values at a given strain and at 0% strain, respectively), but it monotonically decreases during the stretching process. After release, the conductivity can return to its original value, and only a small change is caused by multiple stretching and releasing cycles.

Additionally, the conductive ink can adhere firmly to the surface of the deformable substrate after thermal treatment.

The metal particles (e.g. silver particles) are thus held in an elastomeric matrix of the carrier material and are spaced more or less apart during compression or stretching, thereby affecting the resistance. Furthermore, the reduction in bandwidth during stretching plays a role in resistance change.

The conductor path, and particularly the conductor path made of conductive ink, can be applied with a thickness of 1 μm (micrometer) to 100 μm (micrometer). The conductive ink can be easily applied and has high sensitivity. In particular, the conductor trace can be applied over a partial region or partial length of the sensor substrate or over the entire length of the sensor substrate.

According to another exemplary embodiment, the track-like course of the conductor track runs at least partially in a meandering manner. Thus, a large part of the surface of the sensor carrier, preferably in the fastening section of the mounting body, can be covered with the conductor track, so that the probability of measuring local deformations is increased. In addition, the sensitivity of the conductor track is increased.

According to another exemplary embodiment, the width of the track-like course is between 20 μm (micrometers) and 2500 μm (micrometers), in particular between 25 pm and 2000 pm.

According to another exemplary embodiment, at least two track sections of the track-like course of the conductor track have different track widths. In particular, the conductor track may have one or a plurality of constrictions or taperings at certain points of the fastening section. Knowing the position of the taperings, the location of the deformation for a certain change in resistance can be determined exactly or approximately. The locality of the taperings can determine the preferred direction of the tapered resistance paths of the conductor track and thereby determine the directional dependence of the sensitivity.

According to another exemplary embodiment, an electrically insulating insulation layer is arranged between the surface of the sensor carrier and the conductor track. The insulation layer comprises in particular a polymeric substrate, in particular a thermoplastic film and/or elastomer film. Thus, disturbances in the resistance measurements based on electrical currents between the conductor track and the sensor carrier and/or the hollow rod anchor can be reduced. The layer thickness of the insulation layer can be, for example, between 1 μm (micrometer) and 10000 μm (micrometer), in particular between 15 pm and 5000 pm.

The material of the elastomer substrate is elastic (or flexible) and can support a solid metal layer (or the later formed alloy) on its surface. For example, the material of the elastomer substrate may include at least one polymer material. Suitable examples of the material of the elastomer substrate may include, in particular, thermoplastics, thermosets, and composite materials. In particular, suitable examples of the material of the elastomer substrate include polyurethanes, polyurethane (meth) acrylates, PEG- (meth) acrylates; polyesters such as polyethylene terephthalate (PET), polyethylene naphthalate (PEN), polycarbonate (PC); polysulfones such as polyether sulfone (PES); polyarylates (PAR); polycyclic olefins (PCO); polyimides (PI); polyolefins such as polyethylene (PE), polypropylene (PP); vinyl polymers such as polystyrene (PS), polyvinyl chloride (PVC), polymethyl methacrylate (PMMA); polyamides; polyethers; polyketones such as aromatic polyether ketone (e.g. PEEK); polysulfides (e.g. PPS); fluoropolymers such as polyvinylidene fluoride (P(VDF) such as P(VDF-TrFE)), polytetrafluoroethylene (such as PTFE), fluorinated ethylene propylene (FEP); liquid crystal polymers; polyepoxides; polysiloxanes (such as PDMS); rubber materials such as natural rubber (NR), synthetic natural rubber (IR), nitrile butadiene rubber (NBR), carboxylated nitrile butadiene rubber (XNBR), styrene-butadiene rubber (SBR) and other rubber materials from polymer dispersions and rubber or synthetic rubber lattices; biopolymers or combinations, copolymers and/or mixtures thereof. In particular, the material of the elastomer substrate may include a thermoplastic polyurethane.

In one embodiment, the elastomer substrate may have a tensile modulus of not more than 250 MPa, particularly not more than 200 MPa. The lower limit of the tensile modulus of the elastomer substrate is not particularly limited as long as the elastomer substrate can support a solid metal layer (or the later formed alloy) on its surface. In particular, the elastomer substrate may have a tensile modulus of not less than 25 MPa, particularly not less than 50 MPa. The tensile modulus of the elastomer substrate may be determined, for example, according to ISO 527-1 and 527-3.

According to another exemplary embodiment, the conductor track is designed elastically and applied to the sensor carrier in a stretched and pre-tensioned state. In the un-deformed initial state of the sensor carrier, the elastic conductor track is therefore stretched and under tension. Thus, in the initial state, the conductive particles of the conductor track are spaced further apart and an elastomeric restoring force tries to pull the conductive particles together. If the hollow rod anchor and thus the sensor carrier inserted into the hollow rod anchor are compressed, the conductive particles of the conductor track are pressed closer together due to the restoring force. This increases the conductivity of the conductor track and accordingly reduces the electrical resistance.

Thus, in addition to stretches and fractures of the hollow rod anchor, compressions can also be measured or detected in an improved manner. In comparison, if the conductor track is applied undistorted on the sensor carrier, the conductive particles must be compressed in case of compression. However, this can be difficult, for example, in an undistorted matrix in which the conductive particles are embedded, so that even with strong compression, the conductive particles are only pressed slightly closer together.

The conductor track, which for example has conductive particles embedded in a matrix as carrier material, can be stretched before being applied to the sensor carrier and applied to an undistorted (elastic) substrate or insulation layer. Furthermore, the conductor track can be applied to an undistorted elastic substrate in the undistorted state. Then, the substrate can be stretched together with the conductor track and applied to the sensor carrier in this stretched and pre-tensioned state.

According to another exemplary embodiment, the sensor carrier has a groove in which the conductor track is arranged. In other words, the conductor track is not arranged directly on the outermost surface of the sensor carrier, but in a “protected” outer surface of the sensor carrier within the groove formed in the sensor carrier. The conductor track can be arranged or fastened to the side walls or bottom surface of the groove. Thus, the conductor track can be protected from external influences, particularly during storage or assembly of the sensor carriers.

According to another exemplary embodiment, the (conductor track-containing) groove is filled with a sealing material, wherein the sealing material particularly comprises silicone, polyurethane, and/or acrylic resin. This increases the protection of the conductor track from external influences.

To measure the quality of the fastening between the support (hollow bar anchor) device and the support element, the hollow bar anchor has a sensor carrier inside it, on which a conductor track is arranged in a web-like pattern. The conductor track is supplied with electrical energy, in particular from a head section of the hollow bar anchor located outside the support element.

The term “application of a conductor track” is understood, for example, to mean that the conductor track is already applied (for example, glued) in a fixed state (relaxed or stretched) to the sensor carrier. Furthermore, the term “application of a conductor track” is understood to mean that the conductor track is applied to the sensor carrier as a semi-finished product, for example in a liquid state, by means of a screen printing process, a gravure printing process or an inkjet printing process.

For example, after initial fastening of the anchor (mounting body) provided with the sensor device to the support element, the resistance of the conductor track can be measured. The measured resistance of a correspondingly new and intact fastening is used as the target or initial value. The change in resistance changes with the magnitude of deformation of the conductor track and the corresponding fastening section. Ultimately, a break or separation of the fastening section and accordingly of the conductor track results in an interruption of the conductivity of the conductor track, indicating a destruction of the fastening. In routine checks of the device, the deviation of a measured resistance of the conductor track from the initial target value can thus be measured, and when exceeding or falling below a certain threshold or value the anchor device can be readjusted or replaced or set (drilled and fixed) in an appropriate nearby location. Such a sensor device can be manufactured robustly and cost-effectively, so that the present invention provides a safe and cost-saving condition monitoring for hollow bar anchor devices.

An evaluation unit can be detachably coupled or fixed to the head section to measure the electrical resistance of the conductor track. The evaluation unit can, for example, generate a warning signal that provides information about the quality of the fastening or the device. In other words, the evaluation unit analyzes the measured resistances of the conductor track and compares them with predetermined target values of the resistances. If a resistance of the conductor track changes by a predetermined threshold, the evaluation unit generates corresponding warning signals. The evaluation unit can be an integral part of the device itself or can be coupled to the head section as an external evaluation unit to read out or determine the data regarding the resistances of the conductor track and make them available.

According to another exemplary embodiment, the device is a mountain anchor device and the mounting body is designed as a mountain hollow rod anchor in such a way that the object, in particular a tubbing, can be fastened to the support element, in particular a mountain wall or retaining wall, by means of the supporting element (mounting section) of the hollow rod anchor. Furthermore, the mounting body can be designed as a support anchor to stabilize the support element, for example a mountain wall. The mounting section is inserted into a borehole of the support element and fixed by means of a press connection or a material connection, for example by means of mortar or resin. For example, the object to be fastened, such as a tunnel lining or a tubbing, can be fixed to the mountain anchor. The head section can be visible from the outside and/or hidden and readable by signal technology, so that changes in the electrical resistance of the conductor track along the mounting section can be evaluated by means of an evaluation unit.

According to another exemplary embodiment, the mounting body is designed as a support anchor in such a way that the mounting section is introduced into the support element, in particular a mountain wall or retaining wall, for stabilizing it. Driving in a support anchor or inserting a support anchor with subsequent gluing or mortar filling into a mountain wall or other retaining wall leads to solidification and retention. In the present support anchor as a hollow rod anchor system, it is an “all-in-one” tool for drilling, flushing, and injecting during or after the drilling process, as well as the supporting element (mounting section) itself.

With the inventive support anchor, it is now possible, for example, to detect movements of the mountain wall that are propagated to the support anchor via the conductor tracks on the sensor carrier and thus to detect instability at an early stage.

According to another exemplary embodiment, the anchor (mounting body) is constructed as a hollow rod supporting element (tube), as is known in the art, preferably composed of individual tube sections that can be interconnected, for example, by means of sleeves or nipples or squeeze connections. The individual tubular hollow rod supporting elements (mounting bodies) can additionally or alternatively be designed as lockable tube plug connections with bayonet locks. Such tube plug connections typically comprise a first connection tube with a socket, a second connection tube with an insertable plug-in part that can be inserted into the socket of the first connection tube, and a bayonet connection between the socket and the plug-in part of the two connection tubes. Such a bayonet connection comprises at least one annular groove section and at least one web section and is designed to be closable and releasable by mutual rotation of the socket and the plug-in part. All annular groove sections of the bayonet connection are each delimited on one side by an insertion opening and at least one of the annular groove sections is delimited on the other side by an end stop. The web sections are adapted in their arrangement and dimensions for insertion through the insertion openings of the annular groove sections and are formed to slide in these annular groove sections. In addition, such a tube plug connection can advantageously comprise a device for locking a closed bayonet connection. Each section or part tube section preferably includes a sensor carrier, wherein a coupling of the respective sensor carrier of a section with the sensor carrier of a connected section is formed, preferably via the locking contours or locking connection described above, so that an electrical connection between the sensor carriers is formed.

According to another exemplary embodiment, the tube (the hollow rod), or at least a portion of the tube, has a continuous thread on its outer wall, preferably a continuously cold-rolled round or trapezoidal thread.

According to another exemplary embodiment, the tube (the hollow rod), as is known in itself, has a drilling device, in particular a drilling crown with an opening for a flushing medium that can be fed through the interior of the tube, at one end. With the tube (hollow rod), which is to accommodate the sensor carrier, the borehole can be produced (the supporting element or mounting section assumes the function of the drill rod during the installation process), while the interior can be used for the supply of flushing agent.

According to another exemplary embodiment, the tube (the hollow rod) has a one-way valve in the region of the end of the tube that has the drilling device, which can be opened when pressurized towards the borehole. In this way, for example, binding material can be introduced into the borehole through the interior of the hollow rod, while conversely, e.g., pressurized water cannot enter the interior of the hollow rod.

The method according to the invention for placing a device for determining mechanical loads, in particular tensile and/or compressive stresses, and/or physical loads along a borehole in a substrate (support element e.g. mountain/tunnel wall) involves first drilling the borehole in the substrate and supporting or securing a mounting body, in particular a tube (hollow rod) preferably comprising a sensor carrier in or at the borehole, preferably by introducing a binding agent, e.g. adhesive, rapidly setting concrete or binding agent, preferably supported or fastened in a force-fitting manner, after which the tube (hollow rod) is supported at one end at the borehole by means of a support device, e.g. a thread on the tube with nut or preferably also a wedge, while essentially at least one sensor carrier is introduced into and connected to/with the tube inside the at least one mounting body (tube, hollow rod) located in the borehole. The method according to the invention advantageously also allows the binding agent to be introduced into the borehole through the interior of the hollow rod before the sensor carrier is introduced, so that no separate working step is required for this purpose.

Furthermore, the method according to the invention preferably enables the introduction of a mounting body designed as a hollow rod support element, which consists of several individual sections that can be connected to one another.

According to another exemplary embodiment, preferably before inserting the sensor carrier(s) into the interior of the hollow rod, the latter is cleaned with a detergent, especially a water-air pressure mixture. This can achieve a better connection of the sensor carrier(s) with the inner wall of the hollow rod, and various binding materials can be used for the anchor.

According to another exemplary embodiment, a further binding material, such as a thermosetting plastic mixture, is introduced into the tube (the hollow rod) in which at least one sensor carrier is arranged. This enables particularly simple and precise positioning of the at least one sensor carrier in the mounting body.

### BRIEF DESCRIPTION OF THE DRAWINGS

To further explain and better understand the present invention, exemplary embodiments will be described in more detail below with reference to the accompanying drawings, in which:

FIG. 1 shows a tubular sensor carrier with a groove; a track of electrically conductive ink (conductor track) is arranged in the groove and preferably provided with an insulation layer; the conductor track leads into a contact surface or a contact area in the end section of the sensor carrier.

FIG. 2 shows a sensor carrier like FIG. 1, additionally with a 2nd track of electrically conductive ink (2nd conductor track) arranged in a 2nd groove and preferably provided with an insulation layer; the 2nd conductor track leads into a 2nd contact surface or a 2nd contact area in the end section of the sensor carrier.

FIG. 3 shows a schematic representation of a device for fastening an object to a support element according to an exemplary embodiment of the present invention as a mountain anchor, which is fastened in a mountain wall.

FIG. 4 shows a schematic representation of a device for fastening an object to a support element according to another exemplary embodiment of the present invention as a mountain anchor, which is fastened in a mountain wall.

FIG. 5 shows a schematic representation of a device for fastening an object to a support element according to another exemplary embodiment of the present invention as a mountain anchor, which can be fastened in a mountain wall.

### DETAILED DESCRIPTION OF EXEMPLARY EMBODIMENTS

Same or similar components in different figures are labeled with the same reference numerals. The illustrations in the figures are schematic.

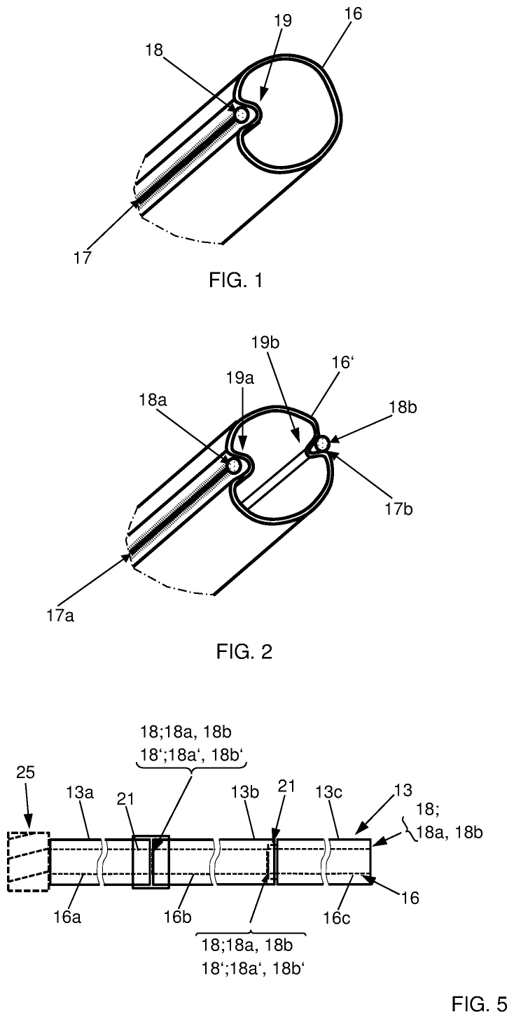

FIG. 1 shows a tubular sensor carrier 16 with a groove 19; a track 17 of an electrically conductive ink (first conductor track 17) is arranged in the groove 19 and preferably provided with an insulating layer; the first conductor track 17 terminates in a contact surface 18 or a contact region 18 in the end section of the sensor carrier 16.

FIG. 2 shows a sensor carrier 16′ similar to that in FIG. 1, but additionally comprising a second conductor track 17b of an electrically conductive ink (second conductor track 17b) arranged in a second groove 19b and preferably provided with an insulating layer; the second conductor track 17b terminates in a second contact surface 18b or a second contact region in the end section of the sensor carrier 16′.

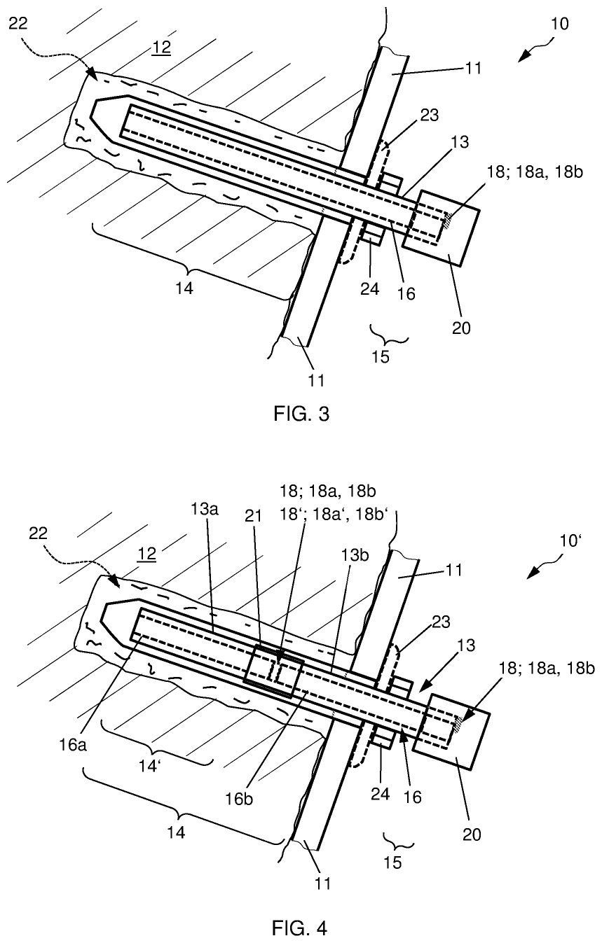

FIGS. 3 and 4 show in respective schematic representations a respective device for attaching an object to a support element according to an exemplary embodiment of the present invention as a rock anchor, which is fixed in a mountain wall.

The rock anchor 10 shown in FIG. 3 is introduced and secured in a mountain wall as a support element 12. The device 10 particularly reinforces or secures a rock surface or a rock surface sealed with mesh or shotcrete or a tunnel lining as an object 11. The device 10 has a condition monitoring for determining deformation. The device 10 has a mounting body 13 with a mounting section 14 for insertion into the support element 12 and a sensor carrier 16 accommodated in the mounting body 13, which sensor carrier 16 has a conductor track (not shown in FIG. 3) that is electrically conductive and applied along a track-shaped course on the sensor carrier 16, for measuring mechanical stress on the mounting section 14, wherein the mounting body 13 has a head section 15 for coupling with an evaluation unit 20, wherein the sensor carrier 16 and/or the conductor track is designed such that it can be supplied with electrical energy from the head section 15, preferably coupled with the evaluation unit 20, wherein the electrical resistance of the conductor track is indicative of the deformation of the mounting body 13 in the mounting section 14. Advantageously, the electrically conductive conductor track terminates in a contact surface or a contact region 18 in an end section of the sensor carrier 16, wherein advantageously the contact surface or the contact region 18 comprises a conductive elastomer body.

The mounting body is advantageously designed as a hollow bar supporting member, in particular as a tube.

The device shown in FIG. 4 as a mountain anchor 10′ is installed and secured in a mountain wall as a support element 12. The device 10′ reinforces or secures in particular a rock surface or a rock surface sealed with mesh or shotcrete or a tubbing as an object 11. The device 10′ has a condition monitoring to determine deformation. The device 10′ has a mounting body 13 with a mounting section 14′ for insertion into the support element 12. In contrast to the mountain anchor 10 of FIG. 3, in this case, the mountain anchor 10′ comprises a mounting body 13 which is designed as a hollow rod support member consisting of several individual, interconnected mounting body sections (referred to as “section(s)” for short), with a first hollow rod support member 13a and a second hollow rod support member 13b being formed, in which case the respective mounting body sections 13a, 13b are connected via a sleeve 21. For this purpose, the end sections of the respective sections 13a, 13b advantageously have a corresponding thread on the outer wall, preferably a continuously cold-rolled round or trapezoidal thread, so that connecting or coupling of the respective sections 13a, 13b via the sleeve 21 is possible.

In this case, each section 13a, 13b preferably has a respective sensor carrier 16a, 16b, and each sensor carrier 16a, 16b has a conductor track (not shown in FIG. 4) which is electrically conductive and is applied along a track-shaped course on the respective sensor carrier 16a, 16b for measuring mechanical stress on the mounting section 14′, wherein the mounting body 13 has a head section 15 for coupling with an evaluation unit 20, in which case the sensor carrier 16 (in this case, in particular, sensor carrier 16b) and/or the conductor track is designed in such a way that it can be supplied with electrical energy from the head section 15 and can preferably be coupled with the evaluation unit 20, wherein the electrical resistance of the conductor track is indicative of the deformation of the mounting body 13 in the mounting section 14′.

For this purpose, the electrically conductive conductor track of the respective sensor carrier 16a, 16b advantageously opens into a respective contact surface or contact area 18′ in a respective end section of the respective sensor carrier 16a, 16b, wherein advantageously the contact surface or the contact area 18′ comprises a conductive elastomer body.

In the present case, the connection of the respective sections 13a, 13b results in a coupling of the respective sensor carrier 16a of the (first) section 13a with the sensor carrier 16b of the (second) section 13b connected via the sleeve 21, so that an electrical connection of the electrically conductive conductor track of the sensor carrier 16a with the electrically conductive conductor track of the sensor carrier 16b of the connected section 13b, preferably via the respective contact surface or contact area 18, 18′, each of which advantageously comprises a conductive elastomer body, is formed or produced.

It should be mentioned that the connection of the respective sections 13a, 13b can alternatively be made via threaded nipples or compression connection(s).

According to the applications shown in FIGS. 3 and 4 above, the fastening section 12 is advantageously secured in an opening of the support element 12 by a material connection, such as mortar 22, in the present case. Furthermore, the device 10, 10′ may optionally have a fastening plate 23 that presses the object 11 against the support element 12, preferably by means of a screw-nut 24 gripping the protruding part of the mounting body 13 from the support element 12.

FIG. 5 shows a mounting body 13 designed as a hollow rod support member made up of several individual mounting body sections (also referred to as “section(s)” for short): first hollow rod support member 13a, second hollow rod support member 13b, and third hollow rod support member 13c, in which case the respective mounting body sections 13a, 13b are advantageously connected by a sleeve 21. To this end, the end portions of the respective sections 13a, 13b preferably have a corresponding thread on the outer wall, preferably a continuously cold-rolled round or trapezoidal thread, so that joining or coupling of the respective sections 13a, 13b via the sleeve 21 is possible. Furthermore, one end of the (third) section 13c is connected to one end of the (second) section 13b via a nipple connection.

In this case, each section 13a, 13b preferably has a respective sensor carrier 16a, 16b, and 16c, and each respective sensor carrier 16a, 16b, 16c has at least one respective conductor track (not shown in FIG. 4) that is electrically conductive and applied along a web-like course on the respective sensor carrier 16a, 16b, 16c, for measuring mechanical stress on a fastening section (not shown in FIG. 5). The mounting body 13 has a head portion (not shown in FIG. 5) for coupling to an evaluation unit (not shown in FIG. 5), in which case the sensor carrier 16 (in this case, in particular sensor carrier 16c) and/or the conductor track (in this case, in particular the conductor track(s) of the (third) sensor carrier 16c) is designed such that it can be supplied with electrical energy from the head portion and/or coupled to the evaluation unit, wherein the electrical resistance of the conductor track is indicative of the deformation of the mounting body 13 in the fastening section.

For this purpose, the electrically conductive conductor track of the respective sensor carrier 16a, 16b, 16c advantageously opens into a respective contact surface or contact region 18, 18′ in a respective end portion of the respective sensor carrier 16a, 16b, 16c, wherein advantageously the contact surface or contact region 18 includes a conductive elastomer body.

In the present case, the connection of the respective sections 13a, 13b couples the sensor carrier 16a of the section 13a to the sensor carrier 16b of the section 13b connected via the sleeve 21, such that an electrical connection of the electrically conductive conductor track of the sensor carrier 16a with the electrically conductive conductor track of the sensor carrier 16b of the connected section 13b, preferably via the respective contact surface or contact region 18, 18′ each preferably comprising a conductive elastomer body, is formed or produced.

Furthermore, in the present case, coupling of the respective sensor carrier 16b of the (second) section 13b with the sensor carrier 16c of the (third) section 13c connected via the nipple connection is achieved by connecting the respective sections 13b and 13c, so that an electrical connection of the electrically conductive conductor track of the sensor carrier 16b with the electrically conductive conductor track of the sensor carrier 16c of the connected section 13c is formed or produced, preferably via the respective contact surface or contact area 18, 18′, which preferably comprise a conductive elastomer body. It should be noted that the connecting of the respective sections 13a, 13b can alternatively be done via threaded nipples or compression connection(s).

According to the applications shown in the above FIGS. 3, 4 and 5, a respective sensor carrier can advantageously be used according to the above description, in particular according to FIGS. 1 and 2, wherein preferably the sensor carrier is fixed or is to be fixed in the mounting body, in particular in force-fitting manner.

Furthermore, the mounting body or a partial body, in particular a tube or hollow rod, can have a drilling device, in particular a drilling crown 25 with an opening for a flushing medium that can be supplied via the interior of the tube. In this way, the borehole can be made using the tube (hollow rod), which is then to house the sensor carrier (the support member or the mounting section takes on the function of the drill rod during the installation process), while at the same time the internal space can be used for the supply of flushing agent.

It should be noted additionally that “comprising” does not exclude other elements or steps and “a” or “an” does not exclude a plurality. Furthermore, it should be noted that features or steps described with reference to one of the above embodiments can also be used in combination with other features or steps of other embodiments described above. Reference numerals in the claims are not to be regarded as limiting.

1. A sensor carrier (16; 16′; 16a, 16b, 16c) for a device (10; 10′) for attaching an object (11) to a support element (12) and/or for stabilizing the support element (12), wherein the device (10; 10′) has a condition monitoring system for determining a deformation and a mounting body (13) with a mounting section (14; 14′) for insertion into the support element (12), wherein the mounting body (13; 13a, 13b; 13a, 13b, 13c) is designed to accommodate a sensor carrier; and wherein the sensor carrier (16; 16′; 16a, 16b, 16c) comprises at least one conductor track (17; 17a, 17b), which conductor track (17; 17a, 17b) is electrically conductive and is applied along a path-like course for measuring mechanical stress on the mounting section (14; 14′).

2. The sensor according to claim 1, characterized in that the electrically conductive conductor track opens into a contact surface or a contact area (18; 18a, 18b) in one or each end section of the sensor carrier (16; 16′; 16a, 16b, 16c).

3. The sensor according to claim 1, characterized in that the sensor carrier (16; 16′; 16a, 16b, 16c) is designed as an extruded plastic profile.

4. (canceled)

5. The sensor according to claim 1, characterized in that the sensor carrier (16; 16′; 16a, 16b, 16c) comprises at least one groove (19; 19a, 19b).

6. The sensor according to claim 5, characterized in that the electrically conductive conductor track is arranged in the groove (19; 19a, 19b).

7. (canceled)

8. (canceled)

9. The sensor according to claim 1, characterized in that the sensor carrier (16; 16′; 16a, 16b, 16c) and/or the at least one groove (19; 19a, 19b) has differently designed locking contours.

10. The sensor according to claim 9, characterized in that the locking contours on an end portion of the groove and/or on one of the two ends of the sensor carrier (16; 16′) have at least one locking projection which is formed raised transversely to the longitudinal direction of the groove and/or the sensor carrier (16; 16′), and at the other end portion of the groove and/or at the other end of the sensor carrier (16; 16′) have at least one locking recess which is formed recessed transversely to the longitudinal direction of the groove, wherein the locking recess and the locking projection are form-fitted to each other, in particular complementary to each other, so that the locking projection can be lowered into the locking recess and can engage therein when a coupling of the sensor carrier (16; 16′) with another such sensor carrier (16; 16′) is made.

11-14. (canceled)

15. The sensor according to claim 1, characterized in that the conductor track (17; 17a, 17b) consists of conductive ink and/or an electrically conductive material and/or a dense arrangement of electrically conductive particles and/or comprises a carrier material in which conductive particles are embedded.

16. The sensor according to claim 1, characterized in that the conductor track (17; 17a, 17b) is fixed to the sensor carrier (16; 16′; 16a, 16b, 16c) in such a way that the conductor track follows corresponding deformations and/or movements of the mounting body (13) provided with the sensor carrier (16; 16′; 16a, 16b, 16c).

17. The sensor according to claim 1, characterized in that the track-like course of the conductor track(s) is at least partially meandering.

18. (canceled)

19. The sensor according to claim 1, characterized in that an electrically insulating insulating layer, in particular a polymeric substrate, in particular a thermoplastic film and/or elastomer film, is arranged between the surface of the sensor carrier (16; 16′; 16a, 16b, 16c) and the conductor track (17; 17a, 17b).

20. (canceled)

21. (canceled)

22. A device (10; 10′) for attaching an object (11) to a support element (12) and/or for stabilizing the support element (12), wherein the device (10; 10′) comprises a condition monitoring for determining deformation, the device (10; 10′) comprising a mounting body (13) with a mounting portion (14; 14′) for insertion into the support element (12), a sensor carrier (16; 16′; 16a, 16b, 16c) received in the mounting body (13) comprising a conductor track (17; 17a, 17b) according to claim 1, which conductor track (17; 17a, 17b) is electrically conductive and is applied along a strip-shaped path on the sensor carrier for measuring mechanical stress on the mounting portion (14; 14′), wherein the mounting body (13) has a head portion (15) for coupling to an evaluation unit (20); and wherein the sensor carrier and/or the conductor track (17; 17a, 17b) is designed such that it can be supplied with electrical energy from the head portion (15), wherein the electrical resistance of the conductor track (17; 17a, 17b) is indicative of the deformation of the mounting body (13) in the mounting portion (14; 14′).

23. The device according to claim 22, characterized in that the mounting body (13) is designed as a hollow rod support member.

24. The device according to claim 22, characterized in that the mounting body (13) or the hollow rod support member consists of several individual sections (13a, 13b; 13a, 13b,13c) connected to each other and each section comprises a sensor carrier.

25-28. (canceled)

29. A method for placing a device for determining mechanical loads, in particular tensile and/or compressive stresses, and/or physical loads along a borehole in a substrate (12), the method comprising:
making a borehole in the substrate (12);
introducing at least one mounting body (13) in/on the borehole;
introducing a bonding compound, in particular an adhesive, a quick-setting concrete or binder, into the borehole for fastening the mounting body (13);
supporting the mounting body (13) at one end of the borehole against the substrate (12) by means of a supporting device, in particular by a threaded rod (24) protruding from the mounting body (13) out of the borehole with a nut (24), characterized by:
accommodating in the interior of the at least one mounting body (13) located in the borehole at least one sensor carrier (16; 16′; 16a, 16b, 16c) according to claim 1.

30. The method according to claim 29, characterized by introducing a mounting body (13) designed as a hollow rod support member consisting of several individual, connectable sections (13a, 13b; 13a, 13b, 13c) and each section comprises a sensor carrier.

31. (canceled)

32. A method according to claim 29, characterized in that a further bonding material, is introduced into the mounting body (13; 13a, 13b; 13a, 13b, 13c) in which at least one sensor carrier (16; 16′; 16a, 16b, 16c) is arranged.
